(19) United States
(12) Patent Application Publication
(10) Pub. No.: US 2014/0035378 A1
(43) Pub. Date: Feb. 6, 2014

(54) PREVENTION OF INTERFERENCE BETWEEN WIRELESS POWER TRANSMISSION SYSTEMS AND TOUCH SURFACES

(71) Applicants: Morris P. Kesler, Bedford, MA (US); Katherine L. Hall, Westford, MA (US); Eric R. Giler, Boston, MA (US); Marin Soljacic, Belmont, MA (US); Konrad J. Kulikowski, North Andover, MA (US)

(72) Inventors: Morris P. Kesler, Bedford, MA (US); Katherine L. Hall, Westford, MA (US); Eric R. Giler, Boston, MA (US); Marin Soljacic, Belmont, MA (US); Konrad J. Kulikowski, North Andover, MA (US)

(73) Assignee: WITRICITY CORPORATION, Watertown, MA (US)

(21) Appl. No.: 13/562,553

(22) Filed: Jul. 31, 2012

(51) Int. Cl. H02J 17/00

(52) U.S. Cl. 307/104

(57) ABSTRACT

A system for managing impacting effects in an electronic system due to the presence of wireless energy transfer oscillating electromagnetic fields includes a controller, a field sensing component communicatively coupled to the controller and configured to measure at least one oscillating energy field and an adjustable filter element communicatively coupled to the controller, wherein the adjustable filter may be adjusted by the controller based, at least in part, on measurements of the field sensing component to reduce effects of the at least one oscillating energy field on the sensing component.

### BACKGROUND

1. Field

This disclosure relates to touch sensors operable during wireless energy transfer and, in particular, to an apparatus to accomplish such sensing.

2. Description of the Related Art

Energy or power may be transferred wirelessly using a variety of known radiative, or far-field, and non-radiative, or near-field, techniques as detailed, for example, in commonly owned U.S. patent application Ser. No. 12/613,686 published on May 6, 2010 as US 2010/010909445 and entitled “Wireless Energy Transfer Systems,” U.S. patent application Ser. No. 12/860,375 published on Dec. 9, 2010 as 2010/0308939 and entitled “Integrated Resonator-Shield Structures,” U.S. patent application Ser. No. 13/222,915 published on Mar. 15, 2012 as 2012/0062345 and entitled “Low Resistance Electrical Conductor,” U.S. patent application Ser. No. 13/283,811 published on ______ as ______ and entitled “Multi-Resonator Wireless Energy Transfer for Lighting,” the contents of which are incorporated by reference.

Wireless energy transfer is interesting for many consumer device applications such as powering and/or charging cell phones, tablets, computers, mini computers, cameras, personal digital assistants, music players, note pads, and the like. Wireless energy transfer may allow the devices to operate or recharge without cables or plugs, increasing their durability, reliability, convenience, and safety.

Many consumer devices as well as equipment and devices used for other applications have touch sensitive surfaces, pads, and/or screens that allow a user to interact with the devices via touch input, hand gestures, stylus input, and the like, and these touch sensitive surfaces may be referred to herein collectively as “touch surfaces”. One particular concern with touch surfaces may be susceptibility to interference owing to the presence of an oscillating electromagnetic field associated with wireless energy transfer systems. Interference caused by the wireless energy transfer systems may manifest itself in the touch surface becoming unresponsive, having reduced sensitivity, or reacting without the user even touching or being in proximity to the surface.

In embodiments, the touch surface technologies may work by capacitive or resistive sensing, that is by monitoring changes to the capacitance or resistance of a sensor. In embodiments, the capacitance or resistance of the sensor may change or a switch may open or close when a finger or other object is touching or is near the touch surface. In touch surfaces embodiments, it may be desirable to detect very small changes in user input requiring detection of very small changes of capacitance and/or resistance and/or other monitored values used to implement the touch surface capabilities. The high sensitivity of the detection process may make the touch surface electronics and sensors susceptible to interference from external electromagnetic fields. Even relatively small amounts of noise introduced from an external source of wireless power may affect the operation of the touch surfaces.

Touch surfaces in electronic devices enabled for wireless energy transfer may be exposed to oscillating magnetic fields and oscillating electric fields. The fields of the wireless energy transfer may sometimes cause interference with the touch surface systems sensing and control circuitry affecting their functionality and sensitivity.

Therefore a need exists for a touch surface that addresses the potential interference problem and allows the touch surface to be usable during wireless energy transfer.

### SUMMARY

In accordance with an exemplary and non-limiting embodiment, a system for managing impacting effects in an electronic system due to the presence of wireless energy transfer oscillating electromagnetic fields, the system comprises a controller, a field sensing component communicatively coupled to the controller and configured to measure at least one oscillating energy field and an adjustable filter element communicatively coupled to the controller, wherein the adjustable filter may be adjusted by the controller based, at least in part, on measurements of the field sensing component to reduce effects of the at least one oscillating energy field on the sensing component.

In accordance with another exemplary and non-limiting embodiment, a wireless energy transfer tolerant touch surface comprises a touch sensing area configured to produce electrical signals indicative of a proximity of a physical object to the touch sensing area, adjustable sensing circuits configured to interpret and drive the electrical signals and a field sensing element communicatively coupled to the adjustable sensing circuits and configured to sense at least one of a frequency and a magnitude of at least one oscillating field used for energy transfer, wherein the at least one of sensed frequency and magnitude of the at least one oscillating field is utilized to adjust the sensing circuits.

In accordance with another exemplary and non-limiting embodiment, a method comprises sensing the frequency of an oscillating field used for wireless energy transfer wherein the oscillating field produces electrical noise in an electronic device and adjusting a filter based, at least in part, on the sensed frequency to reduce electrical noise in the electronic device.

### BRIEF DESCRIPTION OF FIGURES

FIG. 1 is a block diagram of touch surface components according to exemplary and non-limiting embodiments;

FIG. 2 is a block diagram of touch surface components with a communication link between the touch surface and a wireless energy transfer system according to exemplary and non-limiting embodiments;

FIG. 3 is a block diagram of exemplary touch surface components including a field detector element according to exemplary and non-limiting embodiments;

FIG. 4 is a flow diagram of a method according to an exemplary and non-limiting embodiment.

### DETAILED DESCRIPTION

As described above, this disclosure relates to inventive designs for touch surfaces whose function may not be affected or may be minimally affected by interference caused by and during wireless energy transfer. A wireless energy transfer system may comprise resonators that generate and capture the electromagnetic fields used for wireless energy transfer and may comprise high-Q resonators operating at one or more resonant frequencies, ω_{RES}. Extensive discussion of wireless energy transfer systems and their design and operating characteristics is provided, for example, in commonly owned U.S. patent application Ser. No. 12/613,686 published on May 6, 2010 as US 2010/010909445 and entitled “Wireless Energy Transfer Systems,” and incorporated herein by reference in its entirety as if fully set forth herein.

In accordance with exemplary and non-limiting embodiments, a wireless power transfer system may impact the performance of a touch surface. The impacting wireless power transfer signals may be the electromagnetic fields at the resonant frequency, ω_{RES}, and/or the harmonics of the resonant frequency signal of the wireless power system, nω_{RES}, where n is an integer. In embodiments, narrow band filters and/or notch filters may be used to mitigate the impact of the impacting signals by effectively filtering out the impacting signals. In accordance with exemplary and non-limiting embodiments, filters may be used to improve the touch surface performance when the touch surface is operating in an electromagnetic field of a wireless power transfer system.

To minimize the impact of wireless energy transfer signals on the performance of a touch surface, a touch surface may comprise at least one narrow-band rejection filter (rejecting the frequencies close to ω_{RES} and/or nω_{RES}) inside of the touch-pad or touch-screen electronics that may filter out the impacting signal and prevent it from significantly changing the proper operation and/or functioning of the touch surface. The filter may be a hardware based design comprising bulk components such as capacitors, inductors, resistors, operational amplifiers, transmission lines, switches, diodes, and the like, and/or it may comprise software and/or processor code that may be implemented using signal processing techniques in hardware and software running on a micro controller, a processor, a field programmable gate array, an application specific integrated circuit, a computer, a purpose built integrated circuit, and the like. As those skilled in the art will appreciate there are a variety of ways a filter may be implemented on a digital and analog level using any number of known digital and analog signal processing techniques.

A touch surface may include subsystems to address the performance issues associated with ambient electromagnetic fields. The ambient fields may be associated with wireless power transfer systems and they may also be associated with fields generated by other systems.

In one aspect an electronic device may include a field sensing component that may interact with the fields used for wireless energy transfer. The field sensing component may detect the frequency and/or amplitude and/or phase of the fields and may be used to adjust a filter element in the electronic device to filter electronic interference noise caused by the fields. In embodiments the field sensing component may comprise an inductive loop or a high-Q resonator. In embodiments, the field sensing component may comprise electromechanical inductors and/or transformers. In embodiments, the field sensing component may comprise nano-magnets. In embodiments, the field sensing component may be an electric field sensing component and/or a magnetic field sensing component. In embodiments, the field sensor mat be any of a dipole antenna, a loop antenna, a current sensor, a voltage sensor, a thermal sensor, a receiver, and the like.

In another aspect, a touch surface that has a touch sensing area and that outputs electrical signals to sensing circuitry that processes the signals from the touch sensing area may also include a field sensing element that is configured to interact with oscillating electromagnetic fields used for energy transfer and used to sense the frequency of the fields and/or the amplitude of the fields and/or the phase of the fields and may be used to adjust the operation of the sensing circuitry and/or other circuitry to control the operation of the touch surface in the presence of potentially interfering fields of nearby energy transfer systems.

Those skilled in the art will recognize that a particular configuration addressed in this disclosure can be implemented in a variety of other ways. Unless otherwise defined, all technical and scientific terms used herein have the same meaning as commonly understood by one of ordinary skill in the art to which this disclosure belongs. The features described above may be used alone or in combination without departing from the scope of this disclosure. Other features, objects, and advantages of the systems and methods disclosed herein will be apparent from the following description and figures.

In accordance with exemplary and non-limiting embodiments of touch surfaces, at least one filter (software based or hardware based) may be placed between the touch surface and the associated electrical circuit or circuits that process the signal coming from the touch surface. Processing the signal may comprise detecting, monitoring, sensing, measuring, comparing, converting, digitizing, calculating, amplifying, filtering, and regenerating the signal, and the like. In accordance with exemplary and non-limiting embodiments, the at least one narrow band filter may only weakly attenuate the intended touch surface signal's power so that the signal-to-noise ratio in the processing circuitry is still high enough to accurately detect the motion of a finger, object, or a gesture on or near the touch surface.

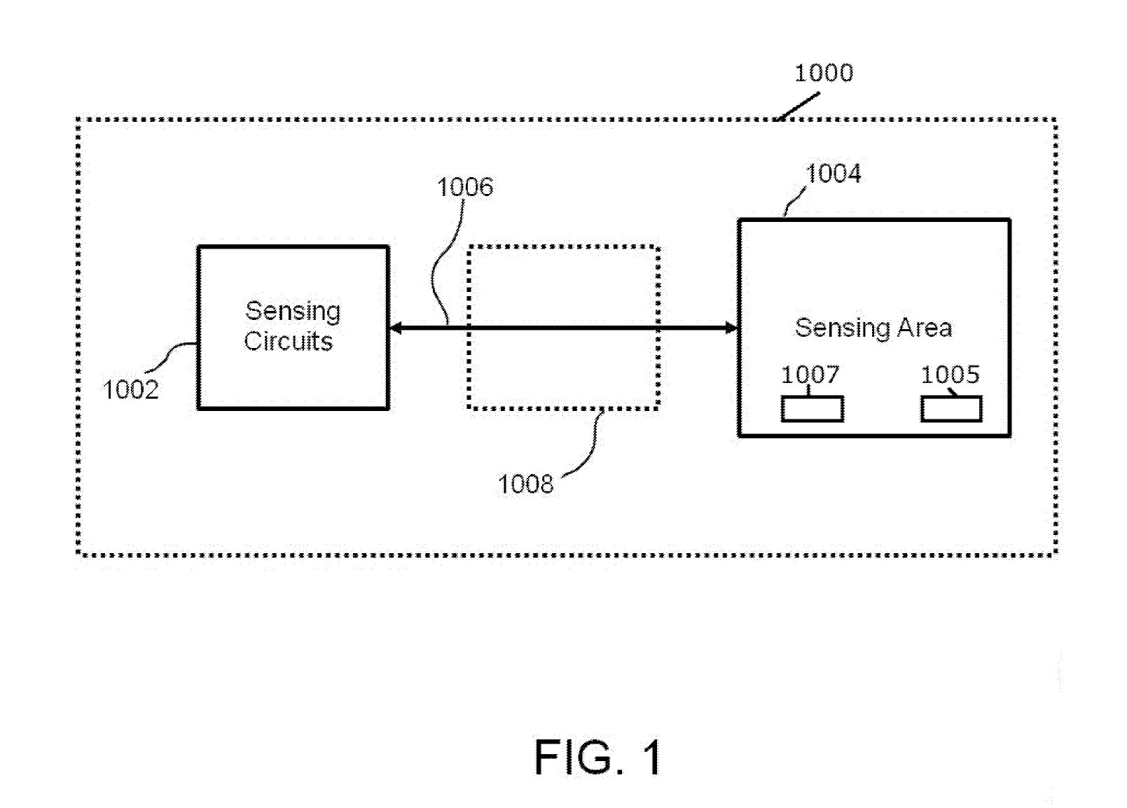

Referring now to FIG. 1, touch surface 1000 may include sensing area 1004, and sensing circuits 1002 that may read and drive sensing area 1004 using electrical signals 1006. Sensing area 1004 may include any type of touch surface sensing technology and may comprise one or more sensors 1005 including, but not limited to, a capacitive sensor, a resistive sensor, inductive sensor and the like. A capacitive sensing area 1004 comprising one or more sensors 1005 may be designed such that pointing objects (fingers, stylus, and the like) affects the capacitance of a sensor 1005 that is then detected by sensing circuits 1002. Likewise, a resistive or an inductive sensing area 1004 may be designed such that pointing objects affect the resistance or the inductance, respectively, of sensor 1005. Sensing circuits 1002 may process the signals from the touch surface and in some embodiments provide a driving signal to the sensing area 1004.

During wireless energy transfer, oscillating magnetic fields may generate electrical noise at the sensors 1005 and/or at the electrical connections between the sensors 1005 and the sensing circuits 1002 and/or in the sensing circuits 1002 themselves. The fields used for wireless energy transfer may change the capacitance of the capacitive sensors or the resistance of the resistive sensors 1005 giving a false indication that a pointing object is close to the surface. The fields used for wireless energy transfer may also induce currents in the wires of the sensors and/or the wires between the sensors 1005 and the sensing circuits 1002 giving false readings of the sensors 1005 and/or masking and/or corrupting the signals and readings from the sensors 1005.

Referring again to FIG. 1, a narrow band filter that is designed to filter signals at the frequency of the fields of the wireless energy transfer may be used to filter the spurious signals caused by the wireless energy transfer fields during wireless energy transfer. In accordance with exemplary and non-limiting embodiments the filter 1008 may be located between the sensing area 1004 and the sensing circuitry 1002 and may be configured to attenuate any spurious or impacting signals that may have been generated in the sensing area and/or the connection wires and/or the sensing circuitry. In accordance with other exemplary and non-limiting embodiments the filter 1008 may be designed into the sensing circuits 1002 to filter the signal output from the touch surface right before it is measured or processed. In accordance with other exemplary and non-limiting embodiments the sensing area 1004 may also comprise additional filters next to the sensors 1005 or next to each individual sensor 1005 of sensing area 1004.

For a wireless energy transfer system operating at 250 kHz, for example, the spurious signal at the touch surface may be confined to electrical noise at substantially 250 kHz or within a couple kilohertz around the 250 kHz center frequency. A narrow band filter that sufficiently attenuates that specific frequency may prevent unwanted interference. In accordance with exemplary and non-limiting embodiments, an attenuation of approximately 10 dB or more at 250 kHz may be sufficient to prevent unwanted interference. Filter characteristics such as selectivity, bandwidth, filter function, order, roll-off, and the like, may depend on the desired operating performance of the touch surface, on the cost target of the touch surface, on the strength of the wireless power transfer fields, on the position and/or orientation of the touch surface relative to the wireless energy transfer fields, and the like. In some accordance with other exemplary and non-limiting embodiments filter 1008 may be chosen to have approximately a 10 dB attenuation for the resonant frequency with at least a 10 dB per decade roll off. Filter 1008 may be a notch filter that preferentially attenuates signals at the wireless power transfer frequency but passes signals at other frequencies with as little loss as possible. In accordance with other exemplary and non-limiting embodiments, wireless energy transfer systems may operate at different frequencies such as 2 MHz, 6.78 MHz, 13.56, MHz, 44 kHz, 20 kHz, 100 kHz, 70-90 kHz, or 145 kHz. In accordance with other exemplary and non-limiting embodiments, wireless power transfer systems may be designed to operate at a wide range of frequencies, from hundreds of Hertz to tens of Gigahertz. In accordance with other exemplary and non-limiting embodiments, filters may be designed to preferentially attenuate signals at any of these frequencies or in any of these frequency bands. In embodiments, filters 1008 may be designed to preferentially attenuate signals at more than one frequency.

In accordance with exemplary and non-limiting embodiments touch surface 1000 may be exposed to, or in the presence of more than one wireless energy transfer system, that may operate at different resonant frequencies. In such environments, the touch surface may be exposed to spurious and/or impacting signals at more than one frequency. In other embodiments, the frequency or frequencies of the fields used for wireless energy transfer may be periodically or continually changing. In still other embodiments, the frequency of or frequencies of the signals used for wireless power may be changed by nonlinear elements in the touch surface or any associated components. For example, signals induced in the associated circuitry may be frequency doubled after passing through diodes. In such environments, the touch surface may be exposed to spurious and/or impacting signals at variable or changing frequencies. To operate in environments with changing frequencies of spurious and/or impacting signals or more than one spurious and/or impacting signal frequency, touch surface 1000 may utilize more than one filter 1008 such as a band-pass filter, notch filter, and/or a tunable band-pass filter or notch filter that may be tuned to attenuate signals at different frequencies.

In accordance with other exemplary and non-limiting embodiments touch surface 1000 may control the center frequency, the bandwidth, the order, the roll-off, the filter function, and the like of any band pass and/or notch filters 1008 associated with sensing area 1004. Touch surface 1000 may occasionally, periodically, continuously, and/or in response to a trigger, adjust the filter 1008 or filters 1008 while monitoring a performance parameter to determine which filter characteristics provide the preferred operation. A controller 1007 forming a part of touch surface 1000 may monitor the touch surface output signals and/or the performance of any circuits or devices that utilize the output signals from touch surface 1000 and based on quantities such as signal jitter, amplitude, variation, stability, signal-to-noise, bandwidth, and the like, select the best, most effective or relatively more effective filter 1008 or filters 1008 to activate or tune to produce the best, most effective or relatively more effective sensing area 1004 output signal.

In accordance with other exemplary and non-limiting embodiments, touch surface 1000 may include an ability to detect or receive information about the frequency or frequencies of operation of the wireless energy transfer system to allow touch surface 1000 to tune the one or more filters 1008 to the appropriate frequency.

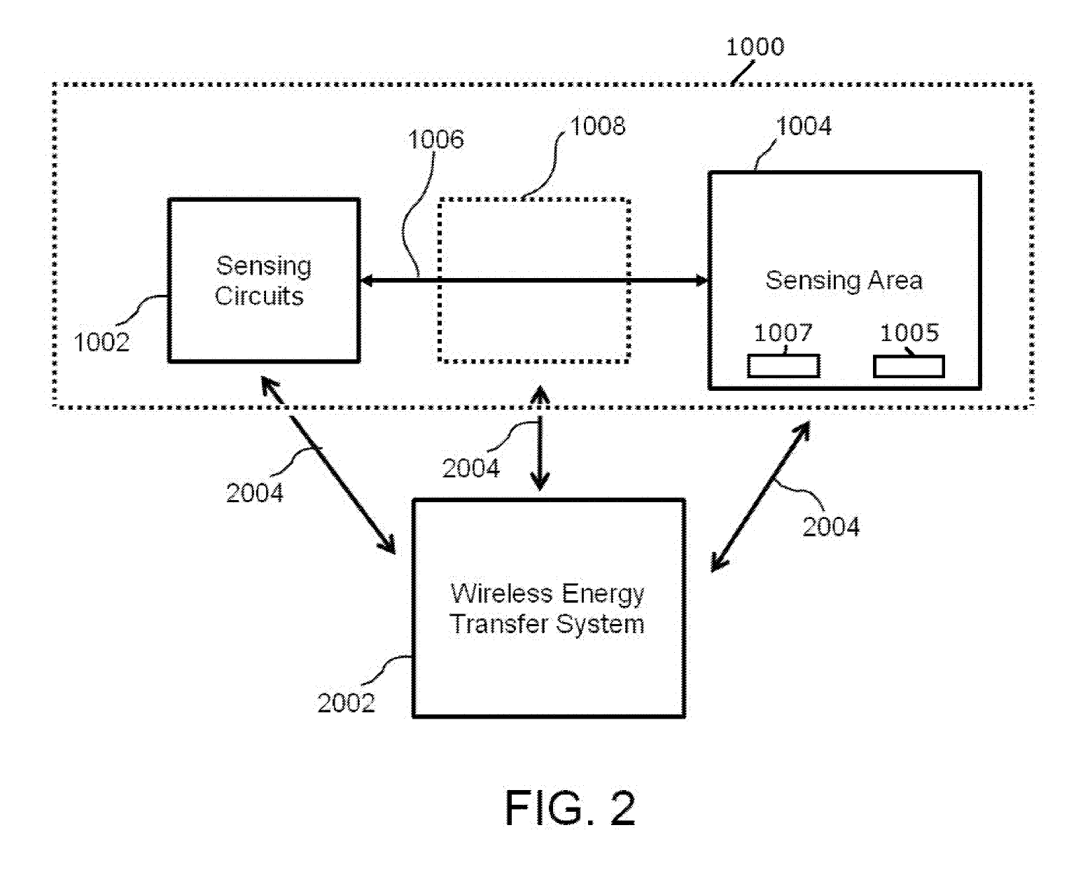

In accordance with another exemplary and non-limiting embodiment, touch surface 1000 may include a communication link between one or more components of the wireless energy transfer system described more fully below with reference to FIG. 2. The communication link may be used to exchange information with the wireless energy transfer system about the parameters of the fields used for wireless energy transfer such that touch surface 1000 may activate the appropriate filters 1008 or spurious and/or impacting signal mitigation techniques. In some exemplary embodiments touch surface 1000 may also send data about its operation behavior and capabilities to the wireless energy transfer system such that the wireless energy system may adjust its operating frequency, output power level, and the like to reduce its impact on the touch surface performance.

Referring now to FIG. 2, an exemplary touch surface 1000 may comprise a sensing area 1004, and sensing circuits 1002 that may read and drive sensing area 1004 using electrical signals 1006 and may also include a communication link 2004 between the components of the wireless energy transfer system 2002 and any component of touch surface 1000. The communication link 2004 may be between wireless energy transfer system 2002 and sensing area 1004, sensing circuits 1002, or any additional or separate filter processing components 1008. Communication link 2004 may be wired. In some exemplary embodiments communication link 2004 may also be wireless in which case touch surface 1000 may further include a wireless communication adaptor (not shown) to send and/or receive the communication to and/or from wireless energy transfer system 2002. The communication between touch surface 1000 and the components of wireless energy transfer system 2002 may be bidirectional. The communication protocol utilized to achieve such bidirectional communication may be custom or may be at least partially based on known communication protocols such as Bluetooth, Zigbee, Near Field Communications (NFC), WiFi, IEEE 802.11, Ethernet, and the like. In accordance with exemplary and non-limiting embodiments, information sent and/or received to and/or from the wireless energy transfer system may comprise information related to the parameters of the wireless energy transfer system 2002. In embodiments, the activity, frequency, power level, and the like, of wireless power transfer system 2002 may be transmitted to touch surface 1000 and the operating parameters of touch surface 1000 may be adjusted based on the information received. For example, filters 1000 of touch surface 1000 may be adjusted to the frequency of the wireless energy transfer fields. In accordance with other exemplary and non-limiting embodiments, the operating parameters of touch surface 1000 may be sent to wireless energy transfer system 2002 and the parameters of the wireless energy transfer system may be adjusted based on the information sent by touch surface 1000. For example, the resonant frequency of wireless energy transfer system 2002 may be adjusted to a frequency for which a certain touch surface 1000 has adequate filtering or to which the touch surface sensors 1005 are immune. In accordance with exemplary and non-limiting embodiments, multiple communication messages may be sent between touch surface 1000 and wireless power transfer system 2002 and the operating parameters of touch surface 1000 and wireless power transfer system 2002 may be adjusted based on negotiated parameters.

In accordance with exemplary and non-limiting embodiments, components of touch surface 1000 and wireless energy transfer system 2000 may be integrated or part of one device or piece of equipment. In such embodiments, both touch surface 1000 and the components of wireless energy transfer system 2002 may be controlled by a central processor or a microcontroller such as embodied by controller 1007. Controller 1007 may comprise a computer usable medium having a computer readable program code embodied therein, said computer readable program code adapted to be executed to, for example, select the operating parameters of touch surface 1000 and wireless energy transfer system 2000 to reduce interference. For example, Controller 1007 may automatically configure the band pass filters and/or notch filters and parameters of touch surface 1000 and the parameters of wireless energy transfer system 2002 to reduce interference by tuning each to the same frequency.

In accordance with exemplary and non-limiting embodiments, touch surface 1000 and the components of wireless energy transfer system 2002 may have limited or no direct communication link. The lack of communication may impact the performance of touch surface 1000 if wireless energy transfer system 2002 does not use a constant or single resonant frequency. For example, in some embodiments wireless energy transfer system 2002 may actively or continually change its operating frequency. That is, the resonant frequency of the resonators of wireless energy transfer system 2002 may perform frequency hopping, changing the frequency of the oscillating magnetic fields. Frequency hopping may be performed for security reasons to prevent unauthorized devices from capturing the wireless energy or to ensure regulatory compliance. In embodiments the frequency hopping may be pseudorandom, or following a special or secret sequence. In accordance with exemplary and non-limiting embodiments, with limited or no communication touch surface 1000 may include a sensing component, such as one of sensors 1005, to determine the frequency of wireless energy transfer such that it may adjust its filters or sensor measurement strategy accordingly.

In accordance with exemplary and non-limiting embodiments where the operating frequency of wireless energy transfer system 2002 cannot be communicated or is not known a priori, touch surface 1000 and/or any associated devices may determine the frequency of wireless energy transfer system 2002, ω_{RES}, for example by detecting a relatively large narrow-band signal present at a device incorporating touch surface 1000, which may be an indication that a wireless power transmission system is present. The device may then proceed to automatically filter-out that particular signal or adjust the operation of the device to reduce the effects of the interference from that signal.

In accordance with exemplary and non-limiting embodiments, touch surface 1000 may include a field sensing element to detect the fields associated with wireless energy transfer. The field sensing element, comprising for example sensor 1005, may be used to detect the frequency of the oscillating fields used for energy transfer and/or their magnitude. Information indicative of the frequency of the fields and/or their magnitude may be used to adjust the operation of touch surface 1000, the center frequency of the band pass filters, the touch detection methods and algorithms used in sensing circuits 1002 and the like. On the fly field detection may allow touch surface 1000 to reduce the impactful effects, such as from interference for example, from the fields used for wireless energy transfer even if the frequency and/or magnitude of the fields is unknown or changing in time.

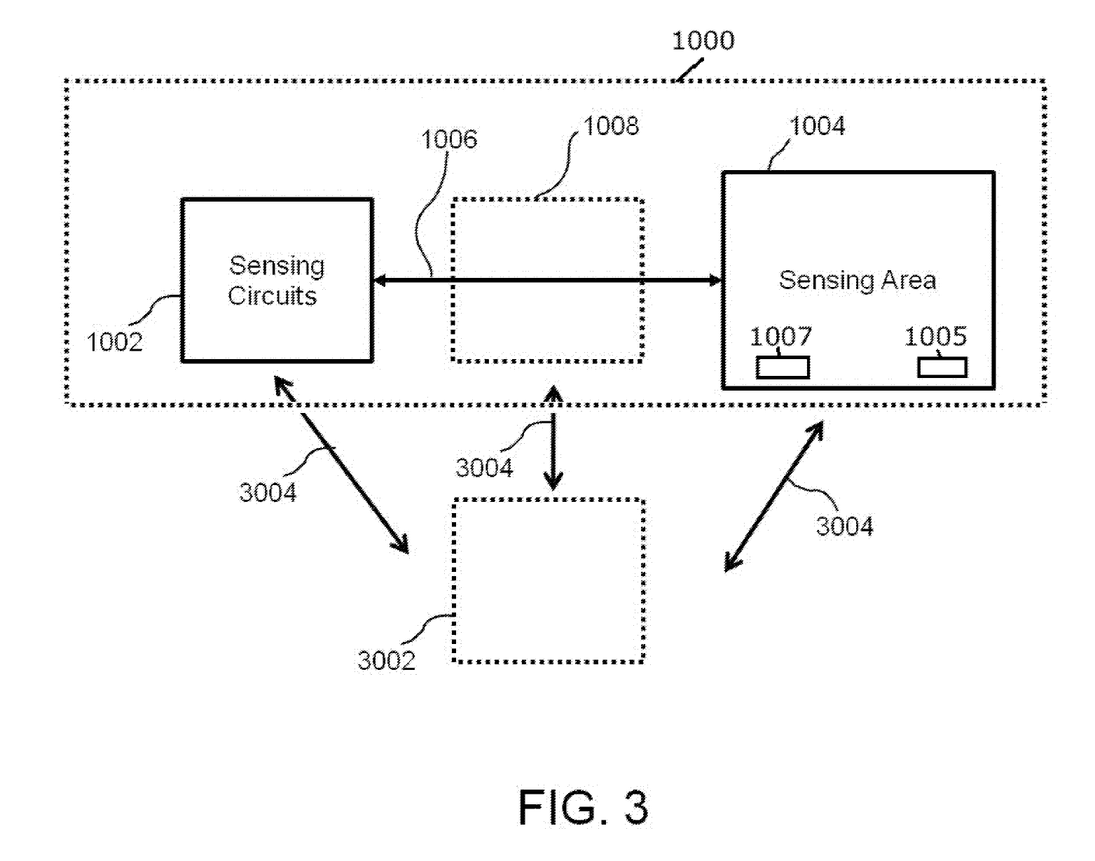

Referring now to FIG. 3, touch surface 1000 includes of sensing area 1004, and sensing circuits 1002 that may read and drive sensing area 1004 using electrical signals 1006 may also include a field sensing element 3002 to sense the frequency, phase, and/or magnitude of the oscillating magnetic fields used for energy transfer. Field sensing element 3002 may have a communication channel or a communication capability 3004 that may be used to transfer information about its sensed readings of the oscillating fields directly or indirectly to touch surface 1000 to control or adjust the operation of touch surface 1000 components based on the readings of the fields.

In accordance with exemplary and non-limiting embodiments, where wireless energy transfer is based on highly-resonant magnetic coupling, the energy transfer is mediated through oscillating electromagnetic fields. For such embodiments, field sensing element 3002 may be configured to detect oscillating magnetic fields. A field detector, forming a part of field sensing element 3002, that may interact with the magnetic fields and be used to detect the frequency and magnitude of the fields, may comprise one or more loops of an electrical conductor forming an inductive loop or coil. Changing the magnetic flux crossing the loop or loops may induce a changing voltage and current at the ends of the loop. The voltage and current at the ends of the loop may oscillate or change at the same frequency as the magnetic fields used for wireless energy transfer. The magnitude of the voltage and current at the ends of the inductive loop may also be proportional or related to the magnitude of the oscillating magnetic fields. By detecting and measuring the voltage and current oscillations at the ends of the inductive coil it may be possible to determine the frequency and the relative magnitude of the fields used for wireless energy transfer. Voltage and current measurements at the end of the inductive loop may be used to detect the frequency and the magnitude of the fields. The voltage and current measurements may be made with equipment and/or circuits comprising detectors, diodes, analog to digital converters, microcontrollers, comparators, operational amplifiers, processors, field programmable gate arrays, and the like. Those skilled in the art will appreciate that there are many ways to measure and analyze current and voltages in a circuit.

In accordance with exemplary and non-limiting embodiments, field sensing element 3002 may be configured to detect oscillating electric fields. A field detector comprising a part of field sensing element 3002 that interact with the electric fields and be used to detect the frequency and magnitude of the fields may comprise one or more dipole or rod antennae. Changing electric fields at the antenna may induce a changing voltage and current at the port of the antenna. The voltage and current at the antenna port may oscillate or change at the same frequency as the electric fields associated with wireless energy transfer. The magnitude of the voltage and current at the antenna port may also be proportional or related to the magnitude of the oscillating electric fields. By detecting and measuring the voltage and current oscillations at the antenna port it may be possible to determine the frequency and the relative magnitude of the fields used for wireless energy transfer. The voltage and current measurements may be made with equipment and/or circuits comprising detectors, diodes, analog to digital converters, microcontrollers, comparators, operational amplifiers, processors, field programmable gate arrays, and the like. Those skilled in the art will appreciate that there are many ways to measure and analyze current and voltages in a circuit.

In accordance with other exemplary and non-limiting embodiments, field sensing element 3002 may include a magnetic resonator. The magnetic resonator may be a resonator similar to the resonators used in highly resonant wireless energy transfer systems 2002 and may comprise one or more loops of a conductor coupled to a capacitive element. The magnetic resonator may have a quality factor of 50 or more. In accordance with exemplary and non-limiting embodiments, the resonator may be a high-Q resonator and may have a quality factor of 100 or more. The magnetic resonator may be able to detect smaller amplitudes or magnitudes of oscillating fields when the oscillations are at the resonant frequency of the resonator.

In accordance with exemplary and non-limiting embodiments, field sensing element 3002 comprising a magnetic resonator may have a tunable resonant frequency. In exemplary embodiments the frequency of the oscillating magnetic fields used for wireless energy transfer may be determined by tuning the sensor resonator over a range of resonant frequencies. To determine the frequency of the fields the resonant frequency of the resonator may be tuned or adjusted over a frequency range. When the resonant frequency of the resonator and the frequency of the oscillating fields used for energy transfer are substantially equal the magnitude of the voltages and currents at the resonator will peak either relatively or absolutely over the tuned frequency range.

In accordance with exemplary and non-limiting embodiments, a high-Q resonator that may be used as field sensor element 3002 may also be used to receive energy wirelessly to power, charge, or supplement the power of the touch surface, the device into which touch surface 1004 is integrated, and the like.

In accordance with exemplary and non-limiting embodiments, field sensing element 3002 may be located near touch surface 1000 or in another location of the device that houses touch surface 1000. In exemplary embodiments, field sensing element 3002 may be placed around touch surface 1000 or it may be integrated into the touch surface elements. For example, an inductive coil may be printed or etched into or around sensing area 1004 providing touch sensing and field sensing in one area.

As discussed above, in some embodiments the impactful effects of the fields associated with wireless energy transfer may be mitigated or reduced with filtering or adjustable band-pass filters and/or notch filters. In other embodiments, the impactful effects may be reduced or mitigated with other techniques that may involve changing other sensor parameters such as the sensing algorithms, sensing frequency, power output, and the like. In accordance with other exemplary and non-limiting embodiments, information from field sensing element 3002 may be used to adjust the algorithms, sensing methods, and the like of the touch surface.

For example, in the case of a touch surface 1000 based on capacitive sensing, the sensing electronics, comprising for example controller 1007, may measure the capacitance of the sensors 1005 using any number of techniques including: the relaxation oscillator method, charge time versus voltage method, voltage divider method, charge transfer method, the sigma-delta modulation method, and the like. In some embodiments a specific sensing method may be preferred due to its low power usage, high sensitivity, small volume, low cost, or the like. In accordance with some exemplary and non-limiting embodiments, the method having the lower power consumption may be more susceptible to interference issues associated with the fields used in wireless power transfer systems. In exemplary embodiments, touch surface 1000 may be capable of changing its sensing method and/or the parameters of the sensing to select a method that may reduce the effects of interferences. For example, when no wireless energy transfer is taking place, touch surface 1000 may use the charge time versus voltage method. When field sensing element 3002 detects wireless energy transfer, touch surface 1000 may switch to a different touch sensing method such as the relaxation oscillator method. If the change did not sufficiently reduce the interference issues at touch surface 1000, touch surface 1000 may increase the voltage of the sensing voltage when the relaxation oscillator method is used thereby increasing the signal to noise ratio. In other embodiments, touch surface 1000 may reduce the sensitivity of touch surface 1000. Those skilled in the art will appreciate that some algorithms and sensing methods may have inherent benefits or interference resilience.

In accordance with exemplary and non-limiting embodiments, when wireless energy transfer is detected, wireless energy transfer may be being used to power or supplement the power of the device with touch surface 1000, making power efficiency of the touch surface less critical and allowing the surface to use sensing methods and algorithms that may have a better interference resilience.

In accordance with other exemplary and non-limiting embodiments, interference due to the fields used for energy transfer may be reduced using active field cancellation. Specifically, touch surface 1000 may include a field generator that may locally cancel or reduce the fields used for wireless energy transfer around touch surface 1000.

In accordance with exemplary and non-limiting embodiments, electronic components other than touch surfaces may be impacted by the presence of oscillating electro-magnetic fields associated with wireless power transmission and similar mitigation strategies may be employed. For example, wireless key fobs used to interact with vehicle locking and ignition systems may comprise sensitive electronic systems that may be overwhelmed and may perform poorly in the presence of wireless power transfer systems. The apparati, methods and systems described herein as relating to touch surfaces could also be applied to wireless keyfobs.

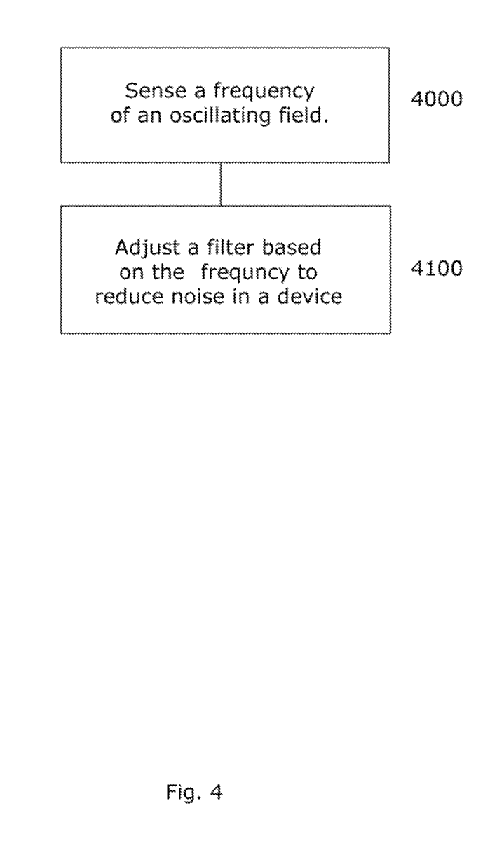

With reference to FIG. 4, there is illustrated an exemplary and non-limiting embodiment of a method. First, at step 4000, a frequency of an oscillating field is sensed. For example, sensor 1005 may sense an oscillating field used for wireless energy transfer wherein the oscillating field produces electrical noise in an electronic device, such as a device comprising touch surface 1000. Next, at step 4100, filter 1008 is adjusted based, at least in part, on the sensed frequency to reduce electrical noise in the electronic device.

Other electronic components that may benefit from the apparati, methods and systems described herein may include any type of radios, wireless actuators, remote controllers, authentication devices, smart cards, and the like.

While the invention has been described in connection with certain preferred embodiments, other embodiments will be understood by one of ordinary skill in the art and are intended to fall within the scope of this disclosure, which is to be interpreted in the broadest sense allowable by law. For example, designs, methods, configurations of components, etc. related to transmitting wireless power have been described above along with various specific applications and examples thereof. Those skilled in the art will appreciate where the designs, components, configurations or components described herein can be used in combination, or interchangeably, and that the above description does not limit such interchangeability or combination of components to only that which is described herein.

All documents referenced herein are hereby incorporated by reference.

What is claimed is:

1. A system for managing impacting effects in an electronic system due to the presence of wireless energy transfer oscillating electromagnetic fields, the system comprising:
a controller;
a field sensing component communicatively coupled to the controller and configured to measure at least one oscillating energy field; and
an adjustable filter element communicatively coupled to the controller, wherein the adjustable filter may be adjusted by the controller based, at least in part, on measurements of the field sensing component to reduce effects of the at least one oscillating energy field on the sensing component.

2. The system of claim 1, wherein the field sensing component comprises an inductive loop.

3. The system of claim 1, wherein the adjustable filter element is a band-pass filter with an adjustable center frequency.

4. The system of claim 1, wherein the sensing components comprise analog to digital converters.

5. The system of claim 3, wherein the field sensing component is configured to detect a frequency of the at least one oscillating field used for energy transfer.

6. The system of claim 1, wherein the field sensing component is configured to detect a magnitude of the at least one oscillating field used for energy transfer.

7. The system of claim 5, wherein a center frequency of the band-pass filter is adjustable to substantially the detected frequency of the at least one oscillating field used for energy transfer.

8. The system of claim 7, wherein an attenuation of the adjustable filter element is adjustable based, at least in part, on a detected magnitude of at least one oscillating field used for energy transfer.

9. A wireless energy transfer tolerant touch surface comprising:
a touch sensing area configured to produce electrical signals indicative of a proximity of a physical object to the touch sensing area,
adjustable sensing circuits configured to interpret and drive the electrical signals; and
a field sensing element communicatively coupled to the adjustable sensing circuits and configured to sense at least one of a frequency and a magnitude of at least one oscillating field used for energy transfer, wherein the at least one of sensed frequency and magnitude of the at least one oscillating field is utilized to adjust the sensing circuits.

10. The touch surface of claim 9, wherein the field sensing element comprises an inductive loop.

11. The touch surface of claim 9, wherein the adjustable sensing circuits are configurable to execute more than one method for interpreting and driving the electrical signals of the touch sensing area and wherein the methods are adjusted based, at least in part, on the at least one of the sensed frequency and magnitude of the fields of the field sensing element.

12. The touch surface of claim 9, wherein the adjustable sensing circuitry comprises an adjustable band-pass filter for filtering electrical noise from the electrical signals of the touch sensing area and wherein the band-pass filter is adjusted based, at least in part, on the at least one of the sensed frequency and magnitude of the at least one oscillating field.

13. The touch surface of claim 10, wherein the inductive loop extends partially around a perimeter of the touch sensing area.

14. The touch surface of claim 9, wherein the field sensing element comprises a tunable high-Q resonator.

15. The touch surface of claim 14, wherein the tunable high-Q resonator has a tunable frequency.

16. The touch surface of claim 14, wherein the tunable high-Q resonator is configured to capture energy to power the touch surface.

17. A method comprising:
sensing the frequency of an oscillating field used for wireless energy transfer wherein the oscillating field produces electrical noise in an electronic device; and
adjusting a filter based, at least in part, on the sensed frequency to reduce electrical noise in the electronic device.
